(19) United States
(12) Patent Application Publication
(10) Pub. No.: US 2026/0057645 A1
(43) Pub. Date: Feb. 26, 2026

(54) IMAGE PROCESSING

(71) Applicant: MASHANG CONSUMER FINANCE CO., LTD., Chongqing (CN)

(72) Inventor: Yejiang ZHOU, Chongqing (CN)

(73) Assignee: MASHANG CONSUMER FINANCE CO., LTD., Chongqing (CN)

(21) Appl. No.: 19/290,221

(22) Filed: Aug. 4, 2025

(30) Foreign Application Priority Data
Aug. 23, 2024 (CN) 202411173978.8

(51) Int. Cl. G06V 10/764; G06V 10/74; G06V 10/80; G06V 20/70

(52) U.S. Cl. CPC G06V 10/764; G06V 10/761; G06V 10/806; G06V 20/70

(57) ABSTRACT

Some aspects of the disclosure provide a method of image processing. For example, one or more text information categories for an image classification of a plurality of images are determined based on one or more parameters that indicate a classification task difficulty level of the image classification of the plurality of images. Respective text information of the plurality of images is extracted, text information of an image in the plurality of images is extracted according to the one or more text information categories. Respective text encoding features of the plurality of images are determined based on the respective text information of the plurality of images. Respective classification labels of the plurality of images are determined based on the respective text encoding features of the plurality of images and respective image encoding features of the plurality of images. Apparatus and non-transitory computer-readable storage medium counterpart embodiments are also contemplated.

### RELATED APPLICATION

The present application claims priority to Chinese Patent Application No. 202411173978.8, filed on Aug. 23, 2024. The entire disclosure of the prior application is hereby incorporated by reference.

### FIELD OF THE TECHNOLOGY

This disclosure relates to the field of data processing technologies, including an image processing method and an image processing apparatus.

### BACKGROUND OF THE DISCLOSURE

With the continuous development of computer technologies, an increasing quantity of requirements are imposed for image processing. Image classification is an image processing technique. Through the image classification, images in an image set are classified into a plurality of classes composed of similar images, thereby realizing arrangement of image information.

In some related examples, in image classification, image classification is performed based on uniformly extracted text information of an image. Since characteristics of different image classification tasks in an actual image classification task scene may be quite different, mismatching easily occurs between the extracted text information and the classification task, resulting an inaccurate classification result.

### SUMMARY

Embodiments of this disclosure provide an image processing method and an image processing apparatus, which help improve accuracy and universality of processing an image classification task.

Some aspects of the disclosure provide a method of image processing. For example, one or more text information categories for an image classification of a plurality of images are determined based on one or more parameters that indicate a classification task difficulty level of the image classification of the plurality of images. Respective text information of the plurality of images is extracted, text information of an image in the plurality of images is extracted according to the one or more text information categories. Respective text encoding features of the plurality of images are determined based on the respective text information of the plurality of images. Respective classification labels of the plurality of images are determined based on the respective text encoding features of the plurality of images and respective image encoding features of the plurality of images.

Some aspects of the disclosure provide an apparatus for image processing that includes processing circuitry configured to perform the method of image processing.

Some aspects of the disclosure also provide a non-transitory computer-readable storage medium storing instructions which when executed by at least one processor cause the at least one processor to perform the method of image processing.

According to a first aspect, an embodiment of this disclosure provides an image processing method, including: determining a text information category of each image based on image differences of a plurality of images and/or a quantity of classification labels; extracting text information corresponding to the text information category of each image; determining a text encoding feature of each image based on the text information of each image; and determining a classification label of each image based on the text encoding feature of each image and an image encoding feature of each image.

It can be understood that the text information category is dynamically selected based on the image differences and/or the quantity of classification labels, and then a matching degree between extracted text information and a classification task is further increased, thereby helping improve the accuracy and universality of processing an image classification task.

According to a second aspect, an embodiment of this disclosure provides an image processing apparatus, including: a first determining unit, configured to determine a text information category of each image based on image differences of a plurality of images and/or a quantity of classification labels; an extraction unit, configured to extract text information corresponding to the text information category of each image; a second determining unit, configured to determine a text encoding feature of each image based on the text information of each image; and a third determining unit, configured to determine a classification label of each image based on the text encoding feature of each image and an image encoding feature of each image.

According to a third aspect, an embodiment of this disclosure provides an electronic device, including a processor (an example of processing circuitry) and a memory having an executable instruction stored therein, the memory having one or more programs stored therein, and when the processor executes the executable instruction stored in the memory, the processor performing the method according to the first aspect.

According to a fourth aspect, an embodiment of this disclosure provides a computer-readable storage medium (e.g., non-transitory computer-readable storage medium), having an energy data management program stored therein, including an executable instruction, and when a processor of an electronic device executes the executable instruction, the processor performing the method according to the first aspect.

According to a fifth aspect, an embodiment of this disclosure provides a computer program product, the foregoing computer program product including a non-transitory computer-readable storage medium storing a computer program, the foregoing computer program being operable to cause a computer to perform some or all of the operations as described in the first aspect of the embodiments of this disclosure. The computer program product may be a software installation package.

It can be understood that in the embodiments of this disclosure, a text information category of each image is first determined based on image differences of a plurality of images and/or a quantity of classification labels; then text information corresponding to the text information category of each image is extracted; a text encoding feature of each image is determined based on the text information of each image; and finally a classification label of each image is determined based on the text encoding feature of each image and an image encoding feature of each image. In this disclosure, compared with the related art in which only text information of the same text information category is extracted, the text information category is dynamically selected based on the image differences and/or the quantity of classification labels, and text information of different dimensions is extracted based on the determined text information category. Since the influence of image differences and a quantitative relation of the classification labels on classification labels in classification tasks is taken into consideration, the extracted text information is more compatible with the classification task, thereby improving the accuracy and universality of processing the image classification tasks.

### BRIEF DESCRIPTION OF THE DRAWINGS

FIG. 1 is a schematic diagram of an architecture of an image processing system according to an embodiment of this disclosure.

FIG. 2 is a flowchart of an image processing method according to an embodiment of this disclosure.

FIG. 3 is a schematic structural diagram of a comprehensive feature extraction model according to an embodiment of this disclosure.

FIG. 4 is a schematic structural diagram of a text feature extraction model according to an embodiment of this disclosure.

FIG. 5 is a schematic flowchart of another image processing method according to an embodiment of this disclosure.

FIG. 6 is a block diagram of composition of functional units of an image processing apparatus according to an embodiment of this disclosure.

FIG. 7 is a block diagram of composition of functional units of another image processing apparatus according to an embodiment of this disclosure.

FIG. 8 is a schematic structural diagram of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Terms “first”, “second” and the like in the disclosure and claims of this disclosure and the foregoing accompanying drawings are used for distinguishing different objects, rather than being used for describing a specific order. In addition, terms “include”, “have”, and any variant thereof are intended to cover a non-exclusive inclusion. For example, a process, a method, a system, a product, or a device that includes a series of operations or units is not limited to the listed operations or units, and instead, further alternatively includes an operation or unit that is not listed, or further alternatively includes another operation or unit that is intrinsic to the process, method, product, or device.

The “embodiment” mentioned in this disclosure can mean that particular features, structures, or characteristics described with reference to the embodiments may be included in at least one embodiment of this disclosure. The phrase appearing at various locations in this disclosure does not necessarily refer to a same embodiment, and is not an independent or alternative embodiment mutually exclusive of another embodiment. It is noted that the embodiments described in the disclosure may be combined with other embodiments.

With the continuous development of computer technologies, an increasing quantity of requirements are imposed for image processing. Image classification is an image processing technique. Through the image classification, images in an image set are classified into a plurality of classes composed of similar images, thereby realizing arrangement of image information. At present, in image classification, only text information of the same text information type is extracted, and image classification is performed based on the foregoing text information. Since image differences and classification labels of different image classification tasks in an actual image classification task scene may be quite different, a current image classification mechanism cannot meet requirements of universality of the classification task and accuracy of a classification result.

In view of the foregoing problem, embodiments of this disclosure provide an image processing method and a related apparatus. First, a text information category of each image is first determined based on image differences of a plurality of images and/or a quantity of classification labels; then text information corresponding to the text information category of each image is extracted; a text encoding feature of each image is determined based on the text information of each image; and finally a classification label of each image is determined based on the text encoding feature of each image and an image encoding feature of each image. In this disclosure, compared with the related art in which only text information of the same text information category is extracted, the text information category is dynamically selected based on the image differences and/or the quantity of classification labels, and text information of different dimensions is extracted based on the determined text information category. Since the influence of image differences and a quantitative relation of the classification labels on classification labels in classification tasks is taken into consideration, the extracted text information is more compatible with the classification task, thereby improving the accuracy and universality of processing the image classification tasks.

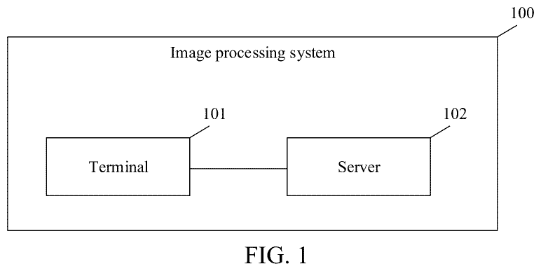

The image processing method and the related apparatus provided in the embodiments of this disclosure may be applied to an image processing system shown in FIG. 1. FIG. 1 is a schematic diagram of an architecture of an image processing system according to an embodiment of this disclosure. The image processing system 100 includes a terminal 101 and a server 102. The terminal 101 may communicate with the server 102 through a network. The terminal 101 refers to a device used by a user, for example, a smartphone or a computer. In this solution, the terminal 101 is mainly responsible for collecting a to-be-classified image set and transmitting the to-be-classified image set to the server 102 for processing. A user may interact with the system through the terminal, transmit a to-be-classified image, or the like. The server 102 refers to a remote computer configured to process a large number of computing tasks and store data. In this solution, the server 102 performs classification processing on the to-be-classified image set transmitted by the terminal 101, and transmits a classification result to the terminal 101.

Accordingly, this disclosure provides an image processing method and a related apparatus. Aspects of the disclosure are described in detail below with reference to the accompanying drawings.

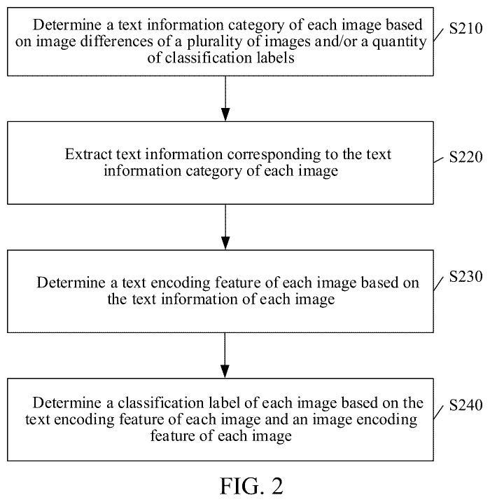

FIG. 2 is a flowchart of an image processing method according to an embodiment of this disclosure. As shown in FIG. 2, the method includes the following operations.

S210: Determine a text information category of each image based on image differences of a plurality of images and/or a quantity of classification labels. In some examples, one or more text information categories for an image classification of a plurality of images are determined based on one or more parameters that indicate a classification task difficulty level of the image classification of the plurality of images.

The image is a to-be-classified image, and may be photos of different scenes, such as a scenery, a person, and a building, may further be images of different items, such as fruit, furniture, and an electronic product, and may further be a medical image, an image of an artistic work, an image of a biological sample, an image captured through a surveillance camera, or the like. The quantity of classification labels corresponds to a current image classification task.

In an aspect, the text information category includes at least one of the following: a sentence-level description of basic image semantics (for example, the basic image semantics are descripted in a manner of one or more sentences), a word-level description of generalized image semantics (for example, the generalized image semantics are descripted in a manner of one or more words), and a word-level description of deep image semantics (for example, the deep image semantics are descripted in a manner of one or more words), the basic image semantics being configured for characterizing a direct description of a scene constructed by some or all elements in an image, the generalized image semantics being configured for characterizing a physical characteristic (e.g., observable, tangible attribute or feature of the scene that can be perceived through the senses, such as sight, touch, sound, or smell) and/or a basic usage characteristic (e.g., a fundamental or primary way that the environment or space of the scene is used or intended to be used) of the scene, the deep image semantics being configured for characterizing a derivative usage characteristic (e.g., a secondary, indirect, or context-dependent way that the environment or space of the scene is used) of the scene, and each of the elements having different descriptive attributes.

An element in an image refers to an object that may be differently identified in the image, which may be for example a tree leaf, a chair, a desk, or a cup in the image. The basic image semantics refers to an intuitive explanation or description of image content, which may include an identified element in the image, an image scene constructed by a plurality of elements, and a basic attribute description of each element, without needing additional knowledge and not involving any implicit meaning, expression of emotion, or subjective judgment, just simply describing what are in the image and how they are arranged. For example, if an image shows an apple on a table, a direct description state of the image may be “a red apple is located on a wooden table”.

The generalized image semantics is answering a specific question based on natural language questions and answers for a visual image and understanding of the image. The question is which keywords describe this picture. A plurality of summarized core keywords in the picture are obtained based on an answer, and these keywords can describe main elements in the image, states and relationships thereof, and basic understanding of a scene constructed by the image. For example, for an image of an apple on a table, keywords may include: an apple bitten and a dining table.

The deep image semantics is to obtain a derivative usage characteristic of an image scene based on natural language questions and answers about a visual image, through a specific goal, or based on domain knowledge. This usage is not content directly shown by the image, but exploring potential, implicit, or symbolic meaning of the image. For example, a picture depicting an empty dining table may be configured to hold an upcoming banquet.

It can be understood that in this embodiment, comprehensiveness of image semantic extraction may be improved.

In an aspect, the determining a text information category based on image differences of a plurality of images and a quantity of classification labels includes: determining an image difference average of the image differences of the plurality of images; and using a parameter group as a query identifier, and querying for a preset text information category set to obtain a text information category that matches the parameter group, the parameter group including the image difference average and the quantity of classification labels, and the text information category set including a correspondence between the parameter group and the text information category.

The image differences may be differences between elements in an image, or differences between scenes constructed by a plurality of elements. For example, for scene differences between images, a scene in a certain image is a city street, and a scene in a certain image is a rural field. For example, for differences between elements in an image, an element in a certain image is a cat, and an element in a certain image is a dog. The classification labels refer to different categories into which images are classified. It is assumed that an image classification task provides 4 classification labels, and a plurality of images in an image set are classified into a beach, a forest, a conference room, and a kitchen.

The image difference average refers to a process of first calculating a difference between every two images to obtain a plurality of image differences, and then calculating an average of these differences when processing a plurality of images.

The parameter group is configured for evaluating classification task difficulty, and the classification task difficulty may be classified into a plurality of difficulty levels. Each difficulty level corresponds to one text information category group, and each difficulty level corresponds to a difficulty range. In an aspect, after the image difference average and the quantity of classification labels are obtained, the image difference average and the quantity of classification labels are normalized, then classification task difficulty corresponding to a plurality of current images is obtained based on a weight of the image difference average and a weight of the quantity of classification labels, then a corresponding difficulty level is found, and an adaptive text information category group is found from a correspondence between a preset difficulty level and a text information category group.

Alternatively, the determining the text information category based on the image differences of the plurality of images and the quantity of classification labels may further be determining a round of text information categories first based on the quantity of classification labels, and then determining the final text information category from the text information categories determined in the first round based on the image differences. In an example, in a case that the quantity of classification labels is less than or equal to the preset quantity, after the determined text information category includes the sentence-level description of the basic image semantics and the word-level description of the generalized image semantics, a difference degree between images continues to be analyzed. If a difference between a plurality of to-be-classified images is relatively large, the sentence-level description of the basic image semantics may be determined, as a final text information category, from the text information category obtained by the quantity of classification labels. If a difference between a plurality of to-be-classified images is relatively small, a word-level description of deep image semantics may be added as a final text information category based on the text information category obtained by the quantity of classification labels.

It can be understood that in this embodiment, flexibility of selecting the text information category is improved, and a success rate and accuracy of determining the text information category are increased, thereby increasing a success rate and accuracy of processing a current image classification task.

In an aspect, the determining a text information category based on image differences of a plurality of images includes: determining an image difference between any two images among the plurality of images to obtain a plurality of image differences; determining that the text information category includes the sentence-level description of the basic image semantics, the word-level description of the generalized image semantics, and the word-level description of the deep image semantics if it is detected that an image difference with a maximum numerical value among the plurality of image differences is less than a preset image difference; and determining that the text information category includes the sentence-level description of the basic image semantics if it is detected that an image difference with a minimum numerical value among the plurality of image differences is greater than the preset image difference.

For a situation where only image differences can be obtained, i.e., in a case that a user does not provide a preset quantity of classification labels, and a device side cannot determine the quantity of classification labels, a difference value between any two to-be-classified images of a plurality of to-be-classified images is calculated, and a maximum difference value and a minimum difference value that are calculated are compared with a preset image difference. If the maximum difference value is less than the preset image difference, it indicates that a difference between the plurality of to-be-classified images is relatively small, and special natural language questions and answers need to be set to obtain differences in picture description texts. In this case, text information of a plurality of dimensions is needed, and then text descriptions of three different dimensions may be determined based on the sentence-level description of the basic image semantics, the word-level description of the generalized image semantics, and the word-level description of the deep image semantics. If the minimum difference value is greater than the preset image difference, it indicates that a difference between the plurality of to-be-classified images is relatively large. In other words, basic semantics of images are already quite different, and a corresponding text description may be determined based on the sentence-level description of the basic image semantics without the need for the generalized image semantics and deep image semantics. Further, in a case that the maximum difference value is not less than the preset image difference, or the minimum difference value is not greater than the preset image difference, the text information category may be determined based on a comparison between the image difference average of the image differences of a plurality of images and the preset image difference.

It can be understood that in this embodiment, a success rate and accuracy of determining the text information category may be increased.

In an aspect, the determining a text information category based on a quantity of classification labels includes: determining that the text information category includes the sentence-level description of the basic image semantics, the word-level description of the generalized image semantics, and the word-level description of the deep image semantics if it is detected that the quantity of classification labels is greater than a preset quantity; and determining that the text information category includes the sentence-level description of the basic image semantics and the word-level description of the generalized image semantics if it is detected that the quantity of classification labels is less than or equal to the preset quantity.

For a situation where only the quantity of classification labels of images can be obtained, i.e., in a case that a user provides a preset quantity of classification labels or a device side determines the quantity of classification labels, a relationship between the quantity of classification labels and the preset quantity is determined. In a case that the quantity of classification labels is less than or equal to the preset quantity, a problem is relatively simple and intuitive, and in-depth domain knowledge is not required. For example, classification labels of a group of simple fruit pictures are red fruit and green fruit, only a basic concept of colors and a method of how to perform classification based on colors need to be learned, without the need to learn complex domain knowledge such as functions of the red fruit and the green fruit, and then text descriptions of two different dimensions may be determined based on a sentence-level description of basic image semantics and a word-level description of generalized image semantics. In a case that the quantity of classification labels is greater than the preset quantity, the problem is relatively complex, and in-depth domain knowledge may be required for analysis. In this way, text descriptions of three different dimensions may be determined based on the sentence-level description of the basic image semantics, the word-level description of the generalized image semantics, and the word-level description of the deep image semantics.

It can be understood that in this embodiment, a success rate and accuracy of determining the text information category may be increased.

S220: Extract text information corresponding to the text information category of each image. In some examples, respective text information of the plurality of images is extracted, text information of an image in the plurality of images is extracted according to the one or more text information categories.

In an aspect, the extracting text information corresponding to the text information category of each image includes: identifying, for the text information category of each image, an element in the image if the text information category includes the sentence-level description of the basic image semantics; determining a scene of the image based on the identified element; and creating a direct descriptive statement of the scene based on a scene vocabulary of the scene and the identified element, and using the direct descriptive statement of the scene as text information of the sentence-level description of the basic image semantics; and identifying an element in the image if the text information category includes the sentence-level description of the basic image semantics and the word-level description of the generalized image semantics; determining a scene of the image based on the identified element; creating a direct descriptive statement of the scene based on a scene vocabulary of the scene and the identified element, and using the direct descriptive statement of the scene as text information of the sentence-level description of the basic image semantics; creating a basic usage descriptor of the scene based on a physical characteristic and/or a basic usage characteristic of the scene, and using the basic usage descriptor of the scene as text information of the word-level description of the generalized image semantics; identifying an element in the image if the text information category includes the sentence-level description of the basic image semantics, the word-level description of the generalized image semantics, and the word-level description of the deep image semantics; determining a scene of the image based on the element; creating a direct descriptive statement of the scene based on a scene vocabulary of the scene and the identified element, and using the direct descriptive statement of the scene as text information of the sentence-level description of the basic image semantics; creating a basic usage descriptor of the scene based on a physical characteristic and/or a basic usage characteristic of the scene, and using the basic usage descriptor of the scene as text information of the word-level description of the generalized image semantics; and creating a derivative usage descriptor of the scene based on a derivative usage characteristic of the determined scene, and using the derivative usage descriptor of the scene as text information of the word-level description of the deep image semantics.

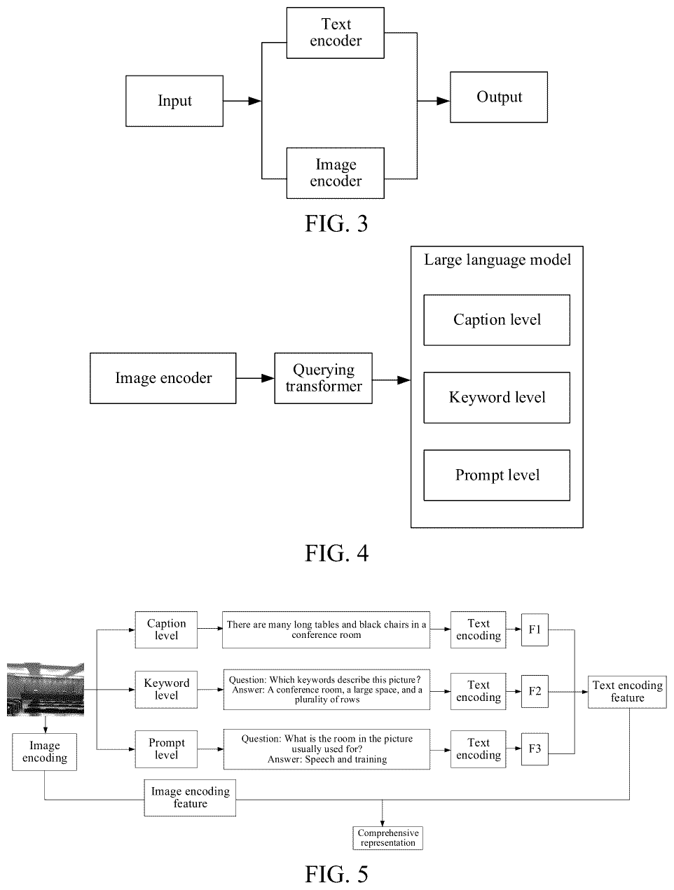

Multi-layer text generation and multi-modal feature extraction may be performed on an image through a trained comprehensive feature extraction model. FIG. 3 is a schematic structural diagram of a comprehensive feature extraction model according to an embodiment of this disclosure. As shown in FIG. 3, the comprehensive feature extraction model may be an image-to-text model, and includes an image encoder and a text encoder. A to-be-classified image is inputted, an image encoding feature and a text encoding feature are respectively obtained through the text encoder and the image encoder, and the image encoding feature and the text encoding feature obtained above are fused to obtain a comprehensive representation and then outputted. The image encoder may be implemented through a convolutional neural network (CNN), may be implemented through a 16-layer Visual Geometry Group (VGG16) architecture for computer vision from the University of Oxford, or may be implemented through a residual network (Resnet). An image-related feature vector is extracted through the image encoder. A specific operation may be encoding an image into a hidden space. In the hidden space, information of the image is compressed and encoded into a group of numeric vectors or feature vectors, thereby retaining key information and features of the original image. Further, the feature vector may include a global image feature and a local image feature. The global image feature may be a color histogram that describes distribution of colors in an image; or may be a texture feature of an image, for example, a grayscale co-occurrence matrix for representing texture coarseness and contrast of the image; and may further be a shape feature for describing an image contour. The local image feature may be a local binary pattern for describing a texture feature of a local region of an image; scale-invariant feature transform; a histogram of oriented gradients for describing a shape and a contour of an object in an image; a speeded-up robust feature, or the like.

The text encoder in the image-to-text model may be implemented through a text feature extraction model that fuses a natural language understanding task and a natural language generation task, and a text encoder in a contrastive language-image pre-training (CLIP) model. A to-be-classified image is inputted, at least one text description for the to-be-classified image may be obtained based on a trained text feature extraction model, and then text information outputted by each layer is converted into a vector representation through the text encoder part in the CLIP model. In this way, a feature vector of important information in text is captured, and the obtained text feature vector is normalized to obtain a text encoding feature.

FIG. 4 is a schematic structural diagram of a text feature extraction model according to an embodiment of this disclosure. As shown in FIG. 4, the text feature extraction model may be bootstrapping language-image pre-training (Blip2) model, or may be another model of the same type. A structure of the text feature extraction model mainly includes the following parts: an image encoder, a querying transformer (Q-Former), and a large language model, where the image encoder, as a visual feature extractor, is kept fixed during pre-training, to reduce calculation costs and avoid a catastrophic forgetting problem. The Q-Former is a trainable module in the BLIP2 model, is a lightweight converter, and includes an image transformation submodule (Image Transformer) and a text transformation submodule (Text Transformer). The two submodules share a self-attention layer. The image transformation submodule is configured to interact with the foregoing image encoder to extract a visual feature, and the text transformation submodule may be used as a text encoder and a text decoder to process text input. The Q-former extracts a visual feature from the image encoder through a group of learned query vectors (Learned Queries). The large language model is configured for text generation, and is also kept fixed during pre-training. Generation layers of the large language model include a plurality of text generation layers, for example, a sentence-level description of basic image semantics, a word-level description of generalized image semantics, and a word-level description of deep image semantics, so as to generate more diversified and in-depth text information, focusing on language features of different dimensions.

The BLIP2 model is trained in two stages. A first stage is vision-language representation learning, in which the Q-former is connected to the image encoder, and pre-training is performed through an image text pair, so that a final Q-former can extract a most relevant visual representation of text, thereby obtaining a high-quality image-text alignment vector representation. A second stage is vision-language generation learning, in which the Q-former is connected to the large language model, an output query embedding of the Q-former is projected onto the same dimension as the embeddings of a plurality of text description layer of the large language model through a fully connected layer, and then text generation is implemented. During pre-training, the Q-former promotes interaction and alignment between vision and language through a specific pre-training task, for example, an image-text comparison learning task, a text generation task based on an image, and an image-text matching task, thereby implementing image text retrieval, image subtitle generation, and visual questions and answers.

As shown in FIG. 4, the large language model includes a plurality of text description layers, which may include 3 text description layers, including a caption level, a keyword level, and a prompt level. The caption level corresponds to a sentence-level description of basic image semantics, the keyword level corresponds to a word-level description of generalized image semantics, and the prompt level corresponds to a word-level description of deep image semantics.

FIG. 5 is a schematic flowchart of another image processing method according to an embodiment of this disclosure. As shown in FIG. 5, an image of a large conference room may be inputted into a comprehensive feature extraction model. It is assumed that 3 text description layers are obtained through a text feature extraction model Blip2. For example, content “there are many long tables and black chairs” in a dialog box is outputted through the caption level, and the outputted content is text information corresponding to the sentence-level description of the basic image semantics. Core keywords are obtained based on questions and answers through the keyword level, for example including “question: which keywords describe this picture?answer: a conference room, a large space, and a plurality of rows”. The answers obtained for the question is text information corresponding to a word-level description of generalized image semantics. A functional description of the picture is acquired based on questions and answers through the prompt layer, for example including “question: what is the room in the picture usually used for?answer: speech and training”, and the answers obtained for the question is text information corresponding to a word-level description of deep image semantics.

It can be understood that in this embodiment, basic or deep text information in the image is extracted, so that the extracted text information is more compatible with the classification task, thereby improving accuracy of the classification task.

S230: Determine a text encoding feature of each image based on the text information of each image. In some examples, respective text encoding features of the plurality of images are determined based on the respective text information of the plurality of images.

As shown in FIG. 5, text encoding is performed on a plurality of text information layers through a contrastive language-image pre-training (CLIP) model, to obtain respective corresponding text representations, which are respectively F1, F2, and F3.

If only one text information category is determined, text information of one dimension is correspondingly outputted, and one text encoding feature is correspondingly extracted. If two or more than two text information categories are determined, text information of a plurality of dimensions is correspondingly outputted, and a plurality of text encoding features are correspondingly extracted. In this case, the plurality of text encoding features need to be fused to obtain a final text encoding feature. In an example, as shown in FIG. 5, it is assumed that 3 text information categories are included, 3 text encoding features are obtained, which are respectively F1, F2, and F3, each text encoding feature is concatenated to obtain a final text encoding feature F. A specific equation is: F=concat (F1, F2, F3).

S240: Determine a classification label of each image based on the text encoding feature of each image and an image encoding feature of each image. In some examples, respective classification labels of the plurality of images are determined based on the respective text encoding features of the plurality of images and respective image encoding features of the plurality of images.

In an aspect, the determining a classification label of each image based on the text encoding feature of each image and an image encoding feature of each image includes: fusing the text encoding feature of each image and the image encoding feature of each image, to obtain a fusion feature of each image; and performing classification processing on the fusion feature of each image, to obtain a classification label of each image.

The image encoding feature is a feature vector related to image content that is outputted by the image encoder in an image-to-text model, and the image content includes at least one of a color, texture, and a shape of an image. The image encoder in the image-to-text model may be the image encoder part in the CLIP model. A to-be-classified image is inputted, the image encoder part in the CLIP model converts the inputted image into a vector representation, i.e., a feature vector of important information in the image is captured, and the obtained image feature vector is normalized to obtain an image encoding feature.

After the text encoding feature outputted by the text encoder and the image encoding feature outputted by the image encoder are obtained, the text encoding feature and the image encoding feature are fused to obtain a comprehensive feature corresponding to the image. In an example, as shown in FIG. 5, a text encoding feature F and an image encoding feature L are concatenated to obtain a comprehensive feature V A specific equation is: V=concat (L, F).

Classification processing is performed on the comprehensive feature V through a classification algorithm, to obtain a classification result. The classification algorithm includes, but is not limited to, a classification algorithm K-Means, a density classification algorithm, a hierarchical classification algorithm, and the like. The classification result includes a classification label for identifying a classification category to which each image belongs, a classification center representing a typical feature or a representative image of each classification, a distance from each image to the classification center to which the image belongs, a similarity measure, and the like.

Further, another feature fusion method may be provided. In an example, feature fusion is performed based on methods such as weighted fusion, cross-modality attention, and conditional batch normalization. In an aspect, a text encoding feature and an image encoding feature are assigned different weights, and then a weighted sum is calculated. Alternatively, an image feature and a text feature are matched through an attention mechanism, thereby implementing more fine-grained feature fusion. Alternatively, conditional batch normalization is adjusted through a text clue in a natural language description, to enhance a visual semantic embedding of a feature map of a generative network.

The encoding feature is not limited to an image and text, and may be extended to incorporate information of more modalities, or may be audio, a video, or the like. A needed modality feature may be extended based on an actual use situation.

It can be understood that in this example, a plurality of layers of text description features are added to image classification, thereby increasing richness of text description, capturing a feature of an image more accurately, and improving accuracy of an image classification result.

It can be understood that in this example, in this disclosure, compared with the related art in which only text information of the same text information category is extracted, the text information category is dynamically selected based on the image differences and/or the quantity of classification labels, and text information of different dimensions is extracted based on the determined text information category. Since the influence of image differences and a quantitative relation of the classification labels on classification labels in classification tasks is taken into consideration, the extracted text information is more compatible with the classification task, thereby improving the accuracy and universality of processing the image classification tasks.

In an implementation example, after a classification result of each image is obtained, all generated text information may be summarized, or all generated text information is inputted into a large model. Based on understanding of an input text, a summative description that briefly and accurately reflects a text description thereof is generated, and then a text similarity of each of the classification result and the summative description is calculated through a text similarity calculation method, to obtain a degree accuracy of the classification result and the text information, or a precise classification evaluation result is calculated through a high-performance model generated from a sentence vector. Further, the foregoing comprehensive feature extraction model can further be adjusted based on the evaluation result. The large model may be a generative pre-trained transformer 3 (GPT-3), and may further be another model of the same type.

It can be understood that in this embodiment, accurate classification performance evaluation may be implemented through the text similarity measure, and accuracy of classification tasks in a plurality of scenes may be improved.

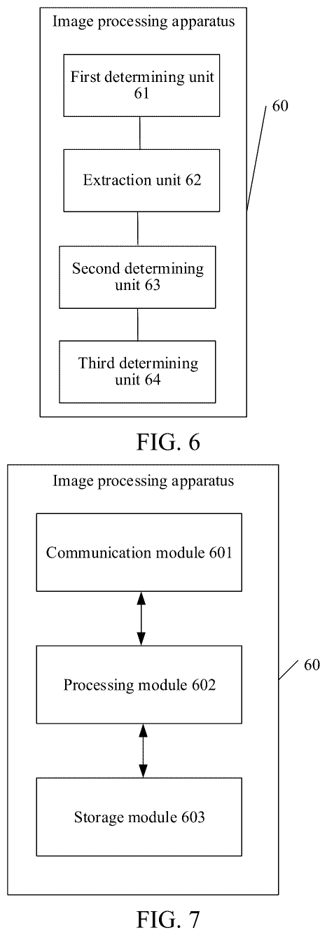

Consistent with the foregoing embodiment, FIG. 6 is a block diagram of composition of functional units of an image processing apparatus according to an embodiment of this disclosure. As shown in FIG. 6, the image processing apparatus 60 includes: a first determining unit 61, configured to determine a text information category of each image based on image differences of a plurality of images and/or a quantity of classification labels; an extraction unit 62, configured to extract text information corresponding to the text information category of each image; a second determining unit 63, configured to determine a text encoding feature of each image based on the text information of each image; and a third determining unit 64, configured to determine a classification label of each image based on the text encoding feature of each image and an image encoding feature of each image.

In some aspects, in terms of the text information category, the text information category includes at least one of the following: a sentence-level description of basic image semantics, a word-level description of generalized image semantics, and a word-level description of deep image semantics, the basic image semantics being configured for characterizing a direct description of a scene constructed by some or all elements in an image, the generalized image semantics being configured for characterizing a physical characteristic and/or a basic usage characteristic of the scene, the deep image semantics being configured for characterizing a derivative usage characteristic of the scene, and each of the elements having different descriptive attributes.

In some aspects, in terms of determining the text information category, the determining a text information category based on image differences of a plurality of images and a quantity of classification labels includes: determining an image difference average of the image differences of the plurality of images; and using a parameter group as a query identifier, and querying for a preset text information category set to obtain a text information category that matches the parameter group, the parameter group including the image difference average and the quantity of classification labels, and the text information category set including a correspondence between the parameter group and the text information category.

In some aspects, in terms of determining the text information category, the first determining unit 61 is further configured to: determine an image difference between any two images among the plurality of images to obtain a plurality of image differences; determine that the text information category includes the sentence-level description of the basic image semantics, the word-level description of the generalized image semantics, and the word-level description of the deep image semantics if it is detected that an image difference with a maximum numerical value among the plurality of image differences is less than a preset image difference; and determine that the text information category includes the sentence-level description of the basic image semantics if it is detected that an image difference with a minimum numerical value among the plurality of image differences is greater than the preset image difference.

In some aspects, in terms of determining the text information category, the first determining unit 61 is further configured to: determine that the text information category includes the sentence-level description of the basic image semantics, the word-level description of the generalized image semantics, and the word-level description of the deep image semantics if it is detected that the quantity of classification labels is greater than a preset quantity; and determine that the text information category includes the sentence-level description of the basic image semantics and the word-level description of the generalized image semantics if it is detected that the quantity of classification labels is less than or equal to the preset quantity.

In some aspects, in terms of extracting text information corresponding to the text information category of each image, the extraction unit 62 is further configured to: identify, for the text information category of each image, an element in the image if the text information category includes the sentence-level description of the basic image semantics; determine a scene of the image based on the identified element; create a direct descriptive statement of the scene based on a scene vocabulary of the scene and the identified element, and use the direct descriptive statement of the scene as text information of the sentence-level description of the basic image semantics; identify an element in the image if the text information category includes the sentence-level description of the basic image semantics and the word-level description of the generalized image semantics; determine a scene of the image based on the identified element; create a direct descriptive statement of the scene based on a scene vocabulary of the scene and the identified element, and use the direct descriptive statement of the scene as text information of the sentence-level description of the basic image semantics; create a basic usage descriptor of the scene based on a physical characteristic and/or a basic usage characteristic of the scene, and use the basic usage descriptor of the scene as text information of the word-level description of the generalized image semantics; identify an element in the image if the text information category includes the sentence-level description of the basic image semantics, the word-level description of the generalized image semantics, and the word-level description of the deep image semantics; determine a scene of the image based on the element; create a direct descriptive statement of the scene based on a scene vocabulary of the scene and the identified element, and use the direct descriptive statement of the scene as text information of the sentence-level description of the basic image semantics; create a basic usage descriptor of the scene based on a physical characteristic and/or a basic usage characteristic of the scene, and use the basic usage descriptor of the scene as text information of the word-level description of the generalized image semantics; and create a derivative usage descriptor of the scene based on a derivative usage characteristic of the determined scene, and use the derivative usage descriptor of the scene as text information of the word-level description of the deep image semantics.

In some aspects, in terms of determining the classification label of each image based on the text encoding feature of each image and the image encoding feature of each image, the third determining unit 64 is further configured to: fuse the text encoding feature of each image and the image encoding feature of each image, to obtain a fusion feature of each image; and perform classification processing on the fusion feature of each image, to obtain a classification label of each image.

Since the method embodiments and the apparatus embodiments are different presentation forms of the same technical concept, aspects of the method embodiments in this disclosure can be adapted to the apparatus embodiments, and details are not described herein again.

In a case that an integrated unit is used, FIG. 7 is a block diagram of composition of functional units of another image processing apparatus according to an embodiment of this disclosure. As shown in FIG. 7, the image processing apparatus 60 includes a processing module 602 and a communication module 601. The processing module 602 is configured to perform control and management on an action of the image processing apparatus 60, for example, perform operations of the first determining unit 61, the extraction unit 62, the second determining unit 63, and the third determining unit 64, and/or is configured to perform other processes of the technology described herein. The communication module 601 is configured for interaction between the image processing apparatus 60 and another device. As shown in FIG. 7, the image processing apparatus 60 may further include a storage module 603. The storage module 603 is configured to store program code and data of the image processing apparatus 60.

The processing module 602 may be processing circuitry such as a processor or a controller, for example, may be a central processing unit (CPU), a general-purpose processor, a digital signal processor (DSP), an application-specific integrated circuit (ASIC), a field programmable gate array (FPGA), or another programmable logic device, a transistor logic device, a hardware component, or any combination thereof. The processing module may implement or execute various exemplary logical blocks, modules, and circuits described with reference to content disclosed in this disclosure. The processor may also be a combination for implementing a computing function, for example, a combination including one or more microprocessors, a combination of the DSP and the microprocessor. The communication module 601 may be a transceiver, an RF circuit, a communication interface, or the like. The storage module 603 may be a memory.

The related content of each scene involved in the foregoing method embodiments may be referred to functional description of a corresponding functional module, and details are not described herein again. The foregoing image processing apparatus 60 may perform the image processing method shown in FIG. 2.

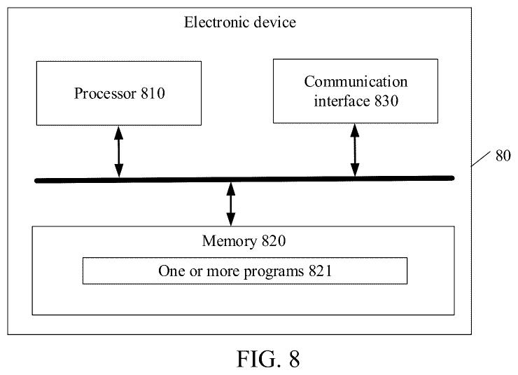

FIG. 8 is a schematic structural diagram of an electronic device according to an embodiment of this disclosure. As shown in FIG. 8, the electronic device 80 includes a processor 810, a memory 820, a communication interface 830, and one or more programs 821. The foregoing one or more programs 821 are stored in the foregoing memory, and are configured to be executed by the foregoing processor. When the program is executed, some or all operations of any image processing method recorded in the foregoing method embodiments are implemented. The processor, the memory, and the communication interface are connected to each other to complete mutual communication.

The memory may be a volatile memory such as a dynamic random access memory (DRAM), or may be a non-volatile memory such as a mechanical hard disk. The foregoing memory is configured to store a set of executable program code, and the foregoing processor above is configured to invoke the executable program code stored in the memory, to perform some or all operations of any energy data management method recorded in the image processing method embodiments above.

It can be understood that the electronic device 80 described in this embodiment of this disclosure first determines a text information category of each image based on image differences of a plurality of images and/or a quantity of classification labels; then extracts text information corresponding to the text information category of each image; determines a text encoding feature of each image based on the text information of each image; and finally determines a classification label of each image based on the text encoding feature of each image and an image encoding feature of each image. In this disclosure, compared with the related art in which only text information of the same text information category is extracted, the text information category is dynamically selected based on the image differences and/or the quantity of classification labels, and text information of different dimensions is extracted based on the determined text information category. Since the influence of image differences and a quantitative relation of the classification labels on classification labels in classification tasks is taken into consideration, the extracted text information is more compatible with the classification task, thereby improving the accuracy and universality of processing the image classification tasks.

An embodiment of this disclosure further provides a computer storage medium, such as a non-transitory computer-readable storage medium, the computer storage medium storing a computer program for electronic data interchange, the computer program causing a computer to perform some or all of the operations of any of the methods as described in the foregoing method embodiments. The foregoing computer includes an electronic device.

An embodiment of this disclosure further provides a computer program product, the foregoing computer program product including a non-transitory computer-readable storage medium storing a computer program. The foregoing computer program is operable to cause a computer to perform some or all of the operations of any of the methods as described in the foregoing method embodiments. The computer program product may be a software installation package, and the foregoing computer includes an electronic device.

To simplify the description, the foregoing method implementations are described as a series of action combination, but it is noted that this disclosure is not limited to a sequence of the actions described, because some operations may be performed in another sequence or simultaneously according to this disclosure. In addition, it is also noted that the implementations described in the disclosure are all examples of implementations, and the involved actions and modules are not required.

In the foregoing implementations, the descriptions of the implementations have respective emphasis. For a part that is not described in detail in a certain implementation, reference may be made to the related descriptions of other implementations.

In the several implementations provided in this disclosure, the disclosed apparatus may be implemented in other manners. For example, the apparatus implementation described above is merely an example. For example, division into the units is merely logical function division, and may be another division during actual implementation. For example, a plurality of units or components may be combined or integrated into another system, or some features may be ignored or not executed. In addition, the displayed or discussed mutual couplings or direct couplings or communication connections may be implemented through some interfaces. The indirect coupling or communication connection between the apparatuses or units may be implemented in an electronic form or another form.

The units described as separate components may or may not be physically separated, and the components displayed as units may or may not be physical units, and may be located in one place or may be distributed on a plurality of network units. Some or all of the units may be selected based on actual needs to achieve the objectives of the solutions of the implementations.

In addition, the functional units in the implementation of this disclosure may be integrated into one processing unit, or each of the units may exist alone physically, or two or more units may be integrated into one unit. The foregoing integrated unit may be implemented in the form of hardware, or may be implemented in a form of a software program module.

If the integrated unit is implemented in the form of the software program module and is sold or used as an independent product, the integrated unit may be stored in a computer-readable memory. Based on such an understanding, the technical solutions of this disclosure may be implemented in a form of a software product. The computer software product is stored in a memory, and includes a plurality of instructions for enabling a computer device (which may be a personal computer, a server, a network device, or the like) to perform all or some of the operations of the method in the implementations of this disclosure. The foregoing memory includes: various media such as a USB flash drive, a read-only memory (ROM), a random access memory (RAM), a mobile hard disk drive, a magnetic disk, or a compact disc that can store program code.

It is noted that all or some operations of the various methods in the foregoing implementations may be performed by instructing related hardware through a program. The program may be stored in a computer-readable memory. The memory may include: a flash disk, a ROM, a RAM, a magnetic disk, a compact disc, or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The implementations of this disclosure are described in detail above, and specific examples are used herein to describe the principle and implementations of this disclosure. The descriptions of the foregoing implementations are only used to help understand the method and the core idea of this disclosure. In addition, it is noted that modifications can be made to the specific implementations and disclosure scope according to the idea of this disclosure. In conclusion, the content is not to be construed as a limitation on the scope of this disclosure.

What is claimed is:

1. A method of image processing, comprising:
determining one or more text information categories for an image classification of a plurality of images based on one or more parameters that indicate a classification task difficulty level of the image classification of the plurality of images;
extracting respective text information of the plurality of images, text information of an image in the plurality of images being extracted according to the one or more text information categories;
determining respective text encoding features of the plurality of images based on the respective text information of the plurality of images; and
determining respective classification labels of the plurality of images based on the respective text encoding features of the plurality of images and respective image encoding features of the plurality of images.

2. The method according to claim 1, wherein the determining the one or more text information categories comprises:
determining the one or more text information categories based on image differences of the plurality of images and/or a quantity of classification labels of the image classification.

3. The method according to claim 2, wherein:
the one or more text information categories comprises at least one of: a sentence-level description of basic image semantics, a word-level description of generalized image semantics, and a word-level description of deep image semantics.

4. The method according to claim 3, wherein the determining the one or more text information categories comprises:
determining an average image difference of the image differences of the plurality of images; and
querying a preset text information category set by using a first parameter group as a query identifier to obtain a first text information category that matches the first parameter group, the first parameter group comprising the average image difference and the quantity of classification labels, and the preset text information category set comprising correspondences between parameter groups and text information categories, the correspondences comprising a correspondence between the first parameter group and the first text information category.

5. The method according to claim 3, wherein the determining the one or more text information categories comprises:
determining the image differences between pairs of images among the plurality of images;
determining that the one or more text information categories comprise the sentence-level description of the basic image semantics, the word-level description of the generalized image semantics, and the word-level description of the deep image semantics when a maximum image difference in the image differences is less than a preset image difference; and
determining that the one or more text information categories comprises the sentence-level description of the basic image semantics when a minimum image difference in the image differences is greater than the preset image difference.

6. The method according to claim 3, wherein the determining the one or more text information categories comprises:
determining that the one or more text information categories comprise the sentence-level description of the basic image semantics, the word-level description of the generalized image semantics, and the word-level description of the deep image semantics when the quantity of classification labels of the image classification is greater than a preset quantity; and
determining that the one or more text information categories comprise the sentence-level description of the basic image semantics and the word-level description of the generalized image semantics when the quantity of classification labels is less than or equal to the preset quantity.

7. The method according to claim 3, wherein the extracting the respective text information comprises:
when the one or more text information categories comprises the sentence-level description of the basic image semantics,
identifying one or more first elements in a first image of the plurality of images,
determining a first scene of the first image based on the one or more first elements,
creating a direct descriptive statement of the first scene based on a scene vocabulary of the first scene and the one or more first elements, and
using the direct descriptive statement of the first scene as first text information of the sentence-level description of the basic image semantics of the first image.

8. The method according to claim 3, wherein the extracting the respective text information comprises:
when the one or more text information categories comprise the sentence-level description of the basic image semantics and the word-level description of the generalized image semantics,
identifying one or more first elements in a first image of the plurality of images,
determining a first scene of the first image based on the one or more first elements in the first image,
creating a direct descriptive statement of the first scene based on a scene vocabulary of the first scene and the one or more first elements,
using the direct descriptive statement of the first scene as first text information of the sentence-level description of the basic image semantics of the first image,
creating a basic usage descriptor of the first scene based on a physical characteristic and/or a basic usage characteristic of the first scene, and
using the basic usage descriptor of the first scene as second text information of the word-level description of the generalized image semantics of the first image.

9. The method according to claim 3, wherein the extracting the respective text information comprises:
when the one or more text information categories comprise the sentence-level description of the basic image semantics, the word-level description of the generalized image semantics, and the word-level description of the deep image semantics,
identifying one or more first elements in a first image of the plurality of images,
determining a first scene of the first image based on the one or more first elements in the first image,
creating a direct descriptive statement of the first scene based on a scene vocabulary of the first scene and the one or more first elements,
using the direct descriptive statement of the first scene as first text information of the sentence-level description of the basic image semantics of the first image,
creating a basic usage descriptor of the first scene based on a physical characteristic and/or a basic usage characteristic of the first scene,
using the basic usage descriptor of the first scene as second text information of the word-level description of the generalized image semantics of the first image,
creating a derivative usage descriptor of the first scene based on a derivative usage characteristic of the first scene, and
using the derivative usage descriptor of the first scene as third text information of the word-level description of the deep image semantics of the first image.

10. The method according to claim 3, wherein the determining the respective classification labels comprises:
fusing a text encoding feature of an image in the plurality of images and an image encoding feature of the image to obtain a fusion feature of the image; and
classifying the image based on the fusion feature of the image to obtain a classification label of the image.

11. An apparatus of image processing, comprising processing circuitry configured to:
determine one or more text information categories for an image classification of a plurality of images based on one or more parameters that indicate a classification task difficulty level of the image classification of the plurality of images;
extract respective text information of the plurality of images, text information of an image in the plurality of images being extracted according to the one or more text information categories;
determine respective text encoding features of the plurality of images based on the respective text information of the plurality of images; and
determine respective classification labels of the plurality of images based on the respective text encoding features of the plurality of images and respective image encoding features of the plurality of images.

12. The apparatus according to claim 11, wherein the processing circuitry is configured to:
determining the one or more text information categories based on image differences of the plurality of images and/or a quantity of classification labels of the image classification.

13. The apparatus according to claim 12, wherein:
the one or more text information categories comprises at least one of: a sentence-level description of basic image semantics, a word-level description of generalized image semantics, and a word-level description of deep image semantics.

14. The apparatus according to claim 13, wherein the processing circuitry is configured to:
determine an average image difference of the image differences of the plurality of images; and
query a preset text information category set by using a first parameter group as a query identifier to obtain a first text information category that matches the first parameter group, the first parameter group comprising the average image difference and the quantity of classification labels, and the preset text information category set comprising correspondences between parameter groups and text information categories, the correspondences comprising a correspondence between the first parameter group and the first text information category.

15. The apparatus according to claim 13, wherein the processing circuitry is configured to:
determine the image differences between pairs of images among the plurality of images;
determine that the one or more text information categories comprise the sentence-level description of the basic image semantics, the word-level description of the generalized image semantics, and the word-level description of the deep image semantics when a maximum image difference in the image differences is less than a preset image difference; and
determine that the one or more text information categories comprises the sentence-level description of the basic image semantics when a minimum image difference in the image differences is greater than the preset image difference.

16. The apparatus according to claim 13, wherein the processing circuitry is configured to:
determine that the one or more text information categories comprise the sentence-level description of the basic image semantics, the word-level description of the generalized image semantics, and the word-level description of the deep image semantics when the quantity of classification labels of the image classification is greater than a preset quantity; and
determine that the one or more text information categories comprise the sentence-level description of the basic image semantics and the word-level description of the generalized image semantics when the quantity of classification labels is less than or equal to the preset quantity.

17. The apparatus according to claim 13, wherein the processing circuitry is configured to:
when the one or more text information categories comprises the sentence-level description of the basic image semantics,
identify one or more first elements in a first image of the plurality of images,
determine a first scene of the first image based on the one or more first elements,
create a direct descriptive statement of the first scene based on a scene vocabulary of the first scene and the one or more first elements, and
use the direct descriptive statement of the first scene as first text information of the sentence-level description of the basic image semantics of the first image.

18. The apparatus according to claim 13, wherein the processing circuitry is configured to:
when the one or more text information categories comprise the sentence-level description of the basic image semantics and the word-level description of the generalized image semantics,
identify one or more first elements in a first image of the plurality of images,
determine a first scene of the first image based on the one or more first elements in the first image,
create a direct descriptive statement of the first scene based on a scene vocabulary of the first scene and the one or more first elements,
use the direct descriptive statement of the first scene as first text information of the sentence-level description of the basic image semantics of the first image,
create a basic usage descriptor of the first scene based on a physical characteristic and/or a basic usage characteristic of the first scene, and
use the basic usage descriptor of the first scene as second text information of the word-level description of the generalized image semantics of the first image.

19. The apparatus according to claim 13, wherein the processing circuitry is configured to:
when the one or more text information categories comprise the sentence-level description of the basic image semantics, the word-level description of the generalized image semantics, and the word-level description of the deep image semantics,
identify one or more first elements in a first image of the plurality of images,
determine a first scene of the first image based on the one or more first elements in the first image,
create a direct descriptive statement of the first scene based on a scene vocabulary of the first scene and the one or more first elements,
use the direct descriptive statement of the first scene as first text information of the sentence-level description of the basic image semantics of the first image,
create a basic usage descriptor of the first scene based on a physical characteristic and/or a basic usage characteristic of the first scene,
use the basic usage descriptor of the first scene as second text information of the word-level description of the generalized image semantics of the first image,
create a derivative usage descriptor of the first scene based on a derivative usage characteristic of the first scene, and
use the derivative usage descriptor of the first scene as third text information of the word-level description of the deep image semantics of the first image.

20. A non-transitory computer-readable storage medium storing instructions which when executed by at least one processor cause the at least one processor to perform:
determining one or more text information categories for an image classification of a plurality of images based on one or more parameters that indicate a classification task difficulty level of the image classification of the plurality of images;
extracting respective text information of the plurality of images, text information of an image in the plurality of images being extracted according to the one or more text information categories;
determining respective text encoding features of the plurality of images based on the respective text information of the plurality of images; and
determining respective classification labels of the plurality of images based on the respective text encoding features of the plurality of images and respective image encoding features of the plurality of images.
